(19) United States
(12) Patent Application Publication
(10) Pub. No.: US 2021/0358439 A1
(43) Pub. Date: Nov. 18, 2021

(54) DRIVE CIRCUIT OF DISPLAY PANEL AND DRIVING METHOD

(71) Applicants: HKC CORPORATION LIMITED, Shenzhen (CN); CHONGQING HKC OPTOELECTRONICS TECHNOLOGY CO., LTD., Chongqing (CN)

(72) Inventor: Yunqin HU, Chongqing (CN)

(21) Appl. No.: 16/339,000

(22) PCT Filed: Oct. 23, 2018
(86) PCT No.: PCT/CN2018/111348

§ 371 Date: Apr. 3, 2019

(30) Foreign Application Priority Data
Sep. 30, 2018 (CN) 201811160497.8

(51) Int. Cl. G09G 3/36

(52) U.S. Cl. CPC G09G 3/3677; G09G 2300/0426; G09G 2310/08; G09G 3/3648

(57) ABSTRACT

The present application discloses a drive circuit of a display panel and a driving method. The display panel includes a display region, a non-display region, and a drive circuit. The display region includes a scan line and a data line. The non-display region includes a gate drive circuit. The drive circuit includes an alignment control line and an active switch.

The present application claims priority to the Chinese Patent Application No. CN201811160497.8, filed to the Chinese Patent Office on Sep. 30, 2018, and entitled “DRIVE CIRCUIT OF DISPLAY PANEL AND DRIVING METHOD”, which is incorporated herein by reference in its entirety.

### TECHNICAL FIELD

The present application relates to the technical field of display, and in particular, to a drive circuit of a display panel and a driving method.

### BACKGROUND

It should be understood that the statements herein merely provide background information related to the present application, and do not necessarily constitute the prior art.

The Polyer-Stabilized Vertical Alignment (PSVA) technology is mainly: controlling tilt of liquid crystals by a Thin Film Transistor (TFT) with gaps, and adding photosensitive polymers to the liquid crystal material; after a panel is composed, applying an electric field to tilt the liquid crystals, and then reacting photosensitive monomers in the liquid crystal by using ultraviolet light so that the liquid crystals produce a pretilt angle in the driving direction of the electric field to achieve multi-domain characteristics. A PSVA alignment circuit adds a shorting bar circuit to the periphery of a chip bonding region. After the alignment is completed, a terminal region of the shorting bar is cut with laser.

The Gate On Array (GOA) technology adopts the same process as the TFT to prepare a line scan drive circuit to realize a progressive scan driving function. It can save the cost of a Gate IC, can also reduce the width of the panel bezel, and is beneficial to the narrow bezel design. It is an important technology of the panel design and has been widely used in the liquid crystal panel. The GOA-architecture panel performs liquid crystal alignment by means of a GOA circuit. Due to the heavy Resistance-Capacitance (RC) load of the circuit during the liquid crystal alignment, it is easy to cause damage and alignment failure of the GOA circuit components.

### SUMMARY

The technical problem to be solved by the present application is to provide a drive circuit of a display panel for reducing load of a GOA circuit during alignment, and a driving method.

To achieve the foregoing objective, the present application provides a drive circuit of a display panel; the display panel includes a display region, a non-display region and a drive circuit; the non-display region surrounds the display region, and includes a gate drive chip connected to the scan lines; the drive circuit includes: an alignment control line intersected with the scan lines; and an active switch with a gate electrode and a source electrode being connected to the alignment control line, and a drain electrode being connected to the scan lines.

Optionally, the alignment control line includes a first alignment control line and a second alignment control line; the active switch includes a first active switch and a second active switch; and the scan line includes a first scan line and a second scan line.

The first active switch is separately connected to the first alignment control line and the first scan line; and the second active switch is separately connected to the second alignment control line and the second scan line.

Optionally, the first scan line and the second scan line are intersected at intervals.

Optionally, the drive circuit further includes:

a gate control line, configured to control the gate drive chip and including a high-level signal line, a low-level signal line, a first clock signal and a second clock signal.

The gate drive chip includes a first gate drive chip and a second gate drive chip; the first gate drive chip is separately connected to the first scan line, the high-level signal line, the low-level signal line, and the first clock signal; and the second gate drive chip is separately connected to the second scan line, the high-level signal line, the low-level signal line, and the second clock signal.

Optionally, the non-display region further includes a data control line; the data control line includes a first data control line and a second data control line; the data line includes a first data line and a second data line; the first data line is connected to the first data control line, and the second data line is connected to the second data control line; and the first data line and the second data line are intersected at intervals.

Optionally, the first scan lines are arranged adjacent to each other; and the second scan lines are arranged adjacent to each other.

Optionally, all the active switches are connected to the same alignment control line.

The present application further discloses a drive circuit of a display panel; the display panel includes a display region and a non-display region; the non-display region surrounds the display region; the driving region includes a plurality of scan lines and a plurality of data lines intersected with the scan lines; the non-display region includes a gate drive chip connected to the scan lines and a data control line connected to the data lines.

The drive circuit includes an alignment control line intersected with the scan lines; and an active switch with a gate electrode and a source electrode being connected to the alignment control line, and a drain electrode being connected to the scan lines.

The alignment control line includes a first alignment control line and a second alignment control line; the active switch includes a first active switch and a second active switch; and the scan line includes a first scan line and a second scan line.

The first active switch is separately connected to the first alignment control line and the first scan line; the second active switch is separately connected to the second alignment control line and the second scan line; and the first scan line and the second scan line are intersected at intervals. The drive circuit further includes: a gate control line, configured to control the gate drive chip and including a high-level signal line, a low-level signal line, a first clock signal and a second clock signal; the gate drive chip includes a first gate drive chip and a second gate drive chip; the first gate drive chip is separately connected to the first scan line, the high-level signal line, the low-level signal line, and the first clock signal; the second gate drive chip is separately connected to the second scan line, the high-level signal line, the low-level signal line, and the second clock signal; the data control line includes a first data control line and a second data control line; the data line includes a first data line and a second data line; the first data line is connected to the first data control line, and the second data line is connected to the second data control line.

The first data line and the second data line are intersected at intervals.

The present application further discloses a driving method for any one of the foregoing embodiments. The driving method further includes:

Close the gate drive chip when it is detected that the potentials of all scan lines are at high level.

The scan lines are conducted line by line when the display panel is normally displayed. Therefore, at the same time point, the gate drive chip only needs to drive one scan line, and the required current is small. During the liquid crystal alignment, all the active switches need to be turned on, so that the entire display region of the display panel forms a complete electric field. Therefore, if the gate drive chip is used to drive all the scan lines at the same time, the load is heavy, and thus it is easy to cause damage to the gate drive chip and failure of alignment. Since the alignment control line is adopted in the present application, the gate drive chip is not used in the alignment, and the scan line is directly powered by the alignment control line, thereby solving the problem that the gate drive chip is heavily loaded. In addition, the gate electrode and the source electrode of the active switch are connected to the alignment control line; when the alignment control line is at high level, the active switch will automatically turn on and pass the voltage to the scan line; however, when the alignment control line is at low level, the active switch will automatically turn off to disconnect the scan line and the alignment control line, without affecting the function of the scan line during normal display. Since the gate electrode of the active switch is not provided with an additional control line, the wiring in the display panel is reduced, the circuit structure and the operating principle are simpler, the difficulty of implementation is reduced, the wiring space is saved, and it is beneficial to achieve narrow bezel.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram of a drive circuit structure of a display panel according to an embodiment of the present application;

FIG. 2 is a schematic diagram of the drive circuit structure of the display panel according to an embodiment of the present application;

FIG. 3 is a drive circuit diagram of the display panel according to an embodiment of the present application;

FIG. 4 is another drive circuit diagram of the display panel according to an embodiment of the present application; and

FIG. 5 is another drive circuit diagram of the display panel according to an embodiment of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying a relative importance, or implicitly indicating the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically coupled; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

The present application is further described below with reference to the accompanying drawings and preferred embodiments.

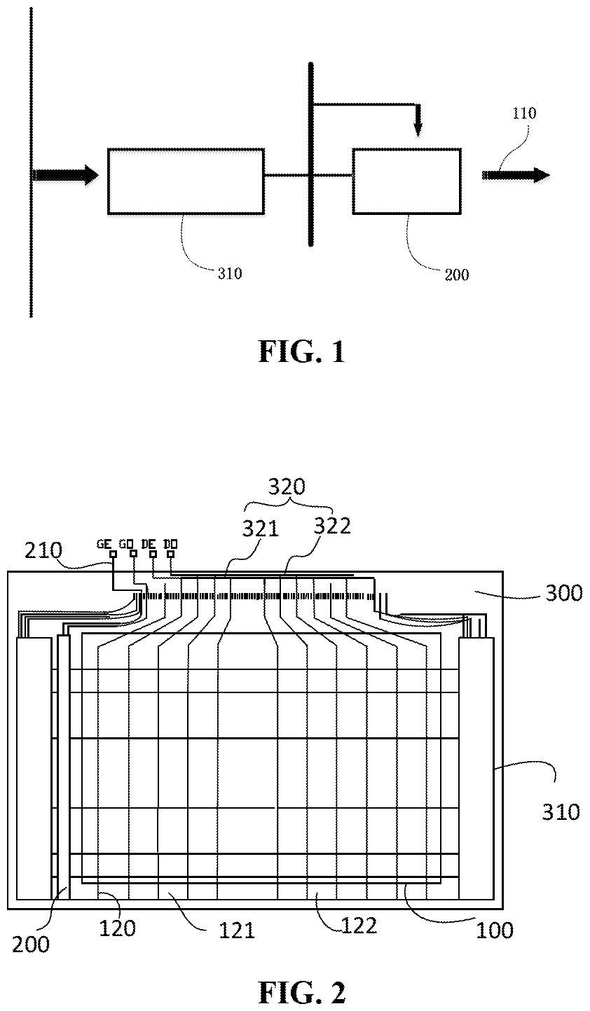

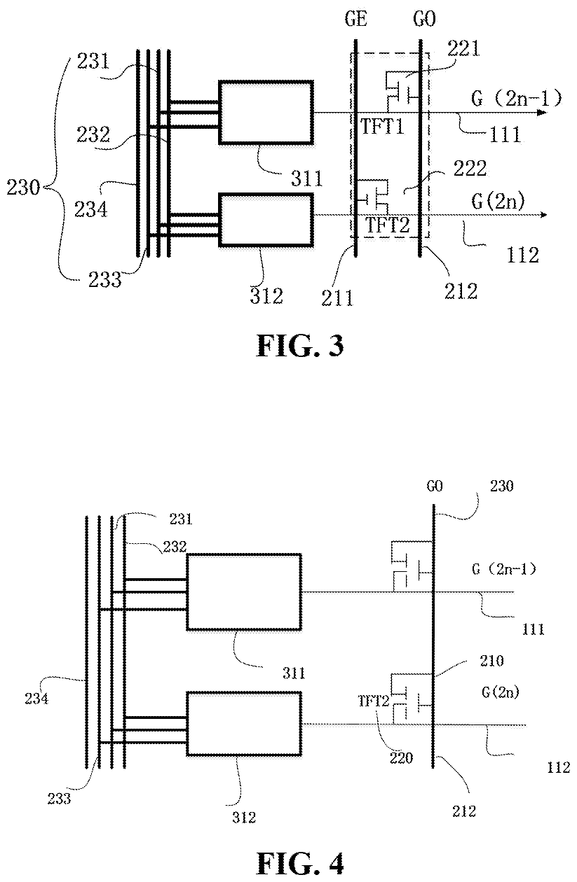

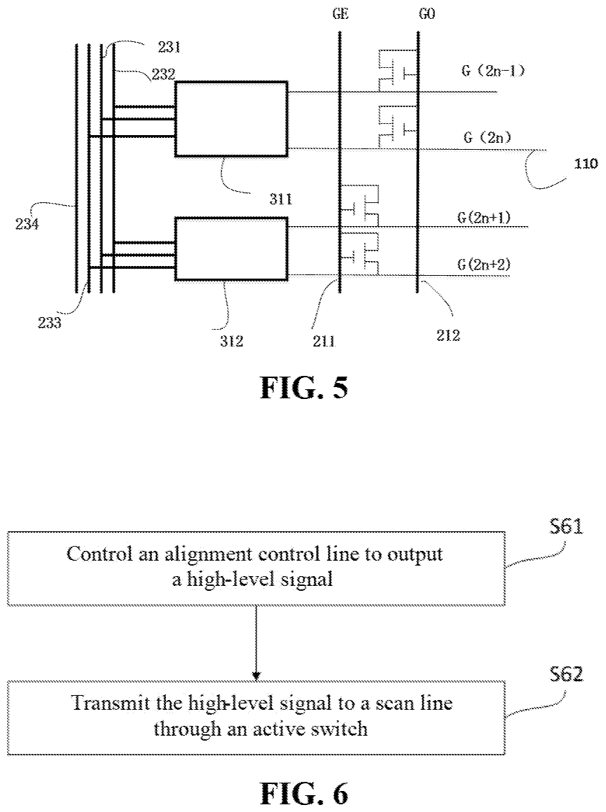

As shown in FIGS. 1-5, an embodiment of the present application discloses a drive circuit 200 of a display panel; the display panel includes a display region 100 and a non-display region 300, the non-display region surrounding the display region; the display region 100 includes a plurality of scan lines 110 and a plurality of data lines 120 intersected with the scan lines 110; the non-display region 300 includes a gate drive chip 310 connected to the scan lines 110; the drive circuit 200 includes an alignment control line 210 intersected with the scan lines 110, and an active switch 220 with a gate electrode and a source electrode being connected to the alignment control line 210, and a drain electrode being connected to the scan lines 110.

The scan lines 110 are conducted line by line when the display panel is normally displayed. Therefore, at the same time point, the gate drive chip only needs to drive one scan line 110, and the required current is small. During the liquid crystal alignment, all the active switches 220 need to be turned on, so that the entire display region 100 of the display panel forms a complete electric field. Therefore, if the gate drive chip 310 is used to drive all the scan lines at the same time, the load is heavy, and thus it is easy to cause damage to the gate drive chip and failure of alignment. Since the alignment control line 210 is adopted in the present application, the gate drive chip is not used in the alignment, and the scan line is directly powered by the alignment control line, thereby solving the problem that the gate drive chip is heavily loaded. In addition, the gate electrode and the source electrode of the active switch 220 are connected to the alignment control line 210; when the alignment control line 210 is at high level, the active switch will automatically turn on and pass the voltage to the scan line 110; however, when the alignment control line 210 is at low level, the active switch 220 will automatically turn off to disconnect the scan line 110 and the alignment control line 210, without affecting the function of the scan line 110 during normal display. Since the gate electrode of the active switch 220 is not provided with an additional control line, the wiring in the display panel is reduced, the circuit structure and the operating principle are simpler, the difficulty of implementation is reduced, the wiring space is saved, and it is beneficial to achieve narrow bezel.

Optionally, in this embodiment, the alignment control line 210 includes a first alignment control line 121 and a second alignment control line 122; the active switch 220 includes a first active switch 221 and a second active switch 222; and the scan line 110 includes a first scan line 111 and a second scan line 112.

The first active switch 221 is separately connected to the first alignment control line 121 and the first scan line 111; and the second active switch 222 is separately connected to the second alignment control line 122 and the second scan line 112.

At the alignment stage, all scan lines 110 are conducted simultaneously, and the driving current is large, and correspondingly, the line width of the alignment control line 210 needs to be enlarged; however, if the line width is enlarged, the superficial area of the alignment control line will be increased, and thus parasitic capacitance generated to surrounding circuits will be increased, and as a result, the quality of display will be affected. The current can be shared by two alignment control lines, and the line width of a single alignment control line is appropriately narrowed to effectively reduce the parasitic capacitance.

Optionally, in this embodiment, the first scan line 111 and the second scan line 112 are intersected at intervals.

A certain difference will be generated between the voltage generated by the first alignment control line 211 and the second alignment line 212 and the circuit, and such difference will be transferred to the first scan line 111 and the second scan line 112; the first scan line 111 and the second scan line 112 are intersected at intervals; and disturbance of electric field generated in the conduction process will cancel out each other, to reduce the RC effect of the line.

Optionally, in this embodiment, the drive circuit 200 further includes:

a gate control line 230, configured to control the gate drive chip 310 and including a high-level signal line 231, a low-level signal line 232, a first clock signal 233 and a second clock signal 234.

The gate drive chip 310 includes a first gate drive chip 311 and a second gate drive chip 322; the first gate drive chip 311 is separately connected to the first scan line 111, the high-level signal line 231, the low-level signal line 232, and the first clock signal 233; and the second gate drive chip 312 is separately connected to the second scan line 112, the high-level signal line 231, the low-level signal line 232, and the second clock signal 234.

The size of the display panel is generally large, while the size of a general integrated chip is relatively small. If a single chip is used to drive the scan line, a fanout region of the wire will be very dense, which is not beneficial to the wiring, and the fanout region is long enough to ensure that pins of the gate drive chip can be connected to each scan line, which increases the thickness of the bezel undoubtedly. Therefore, two gate drive chips are used to respectively drive two sets of scan lines, which is beneficial to reduce the length of the fanout region, achieving a narrow bezel and reducing the difficulty of wiring at the same time. In addition, the two gate drive chips share a high-level signal line and a low-level signal line in the gate control line, which reduces the number of gate control lines, and is also beneficial to reduce the width of the bezel.

Optionally, in this embodiment, the non-display region 300 further includes:

a data control line 320.

The data control line 320 includes a first data control line 321 and a second data control line 322.

The data line 120 includes a first data line 121 and a second data line 122.

The first data line 121 is connected to the first data control line 321, and the second data line 122 is connected to the second data control line 322.

The first data line 121 and the second data line 122 are intersected at intervals.

At the alignment stage, all data lines are conducted simultaneously, and the driving current is large, and correspondingly, the line width of the data control line 320 needs to be enlarged; however, if the line width is enlarged, the superficial area of the data control line will be increased, and thus parasitic capacitance generated to surrounding circuits will be increased, and as a result, the quality of display will be affected. The current can be shared by two data control lines 320, and the line width of a single alignment control line is appropriately narrowed to effectively reduce the parasitic capacitance.

Optionally, in this embodiment, the first scan lines 111 are arranged adjacent to each other; and the second scan lines 122 are arranged adjacent to each other.

The scan lines 110 connected to the same alignment control line 210 are sorted together, and the consistency is good, i.e., a same alignment control line is connected between two adjacent first scan lines 111 or second scan lines 112, and the voltage and current are consistent when energized, which can effectively prevent common-mode interference.

Optionally, in this embodiment, all the active switches 220 are connected to the same alignment control line 210.

A single alignment control line is used, and the alignment line occupies smaller space, which is beneficial to reduce the bezel of the display panel and meet the trend of narrow bezel.

As another embodiment of the present application, with reference to FIGS. 1-5, disclosed is a drive circuit of a display panel.

The display region 100 includes:

a plurality of scan lines 110; and

a plurality of data lines 120 intersected with the scan lines 110.

The non-display ergion 300 includes:

a gate drive chip 310 connected to the scan lines 110.

The drive circuit includes:

an alignment control line 210 intersected with the scan lines 110; and an active switch 220 with a gate electrode and a source electrode being connected to the alignment control line 210, and a drain electrode being connected to the scan lines 110.

The alignment control line 210 includes a first alignment control line 211 and a second alignment control line 212; the active switch 220 includes a first active switch 221 and a second active switch 222; and the scan line 110 includes a first scan line 111 and a second scan line 112.

The first active switch 221 is separately connected to the first alignment control line 121 and the first scan line 111; and the second active switch 222 is separately connected to the second alignment control line 122 and the second scan line 112.

The first scan line 111 and the second scan line 112 are intersected at intervals.

The drive circuit 200 further includes:

a gate control line 230, configured to control the gate drive chip 310 and including a high-level signal line 231, a low-level signal line 232, a first clock signal 233 and a second clock signal 234.

The gate drive chip 310 includes a first gate drive chip 311 and a second gate drive chip 322; the first gate drive chip 311 is separately connected to the first scan line 111, the high-level signal line 231, the low-level signal line 232, and the first clock signal 233; and the second gate drive chip 312 is separately connected to the second scan line 112, the high-level signal line 231, the low-level signal line 232, and the second clock signal 234.

The non-display region 300 further includes:

a data control line 320.

The data control line 320 includes a first data control line 321 and a second data control line 322.

The data line 120 includes a first data line 121 and a second data line 122.

The first data line 121 is connected to the first data control line 321, and the second data line 122 is connected to the second data control line 322.

The first data line 121 and the second data line 122 are intersected at intervals.

As another embodiment of the present application, with reference to FIG. 6, disclosed is a driving method for the drive circuit of the display panel according to any one of the foregoing embodiments, including the following steps:

S61. Control an alignment control line to output a high-level signal.

S62. Transmit the high-level signal to a scan line through an active switch.

Optionally, in this embodiment, the gate drive chip is closed when it is detected that the potentials of all scan lines are at high level.

The technical solution of the present application can be widely applied to flat-panel displays such as a Thin Film Transistor-Liquid Crystal Display (TFT-LCD) and an Organic Light-Emitting Diode (OLED) display.

The contents above are further detailed descriptions of the present application in conjunction with specific embodiments, and the specific implementation of the present application is not limited to these descriptions. It will be apparent to a person of ordinary skill in the art that various simple deductions or substitutions may be made without departing from the spirit of the present application, and should be considered to be within the scope of protection of the present application.

What is claimed is:

1. A drive circuit of a display panel, the display panel comprising a display region, a non-display region and a drive circuit, the non-display region surrounding the display region;
the display region comprises:
a plurality of scan lines; and
a plurality of data lines intersected with the scan lines;
the non-display region comprises:
a gate drive chip connected to the scan lines;
the drive circuit comprises:
an alignment control line intersected with the scan lines; and
an active switch with a gate electrode and a source electrode being connected to the alignment control line, and a drain electrode being connected to the scan lines.

2. The drive circuit of a display panel according to claim 1, wherein the alignment control line comprises a first alignment control line and a second alignment control line; the active switch comprises a first active switch and a second active switch; and the scan line comprises a first scan line and a second scan line;
the first active switch is separately connected to the first alignment control line and the first scan line; and the second active switch is separately connected to the second alignment control line and the second scan line.

3. The drive circuit of a display panel according to claim 2, wherein the first scan line and the second scan line are intersected at intervals.

4. The drive circuit of a display panel according to claim 2, wherein the drive circuit further comprises:
a gate control line, configured to control the gate drive chip and comprising a high-level signal line, a low-level signal line, a first clock signal and a second clock signal;
the gate drive chip comprises a first gate drive chip and a second gate drive chip; the first gate drive chip is separately connected to the first scan line, the high-level signal line, the low-level signal line, and the first clock signal; and the second gate drive chip is separately connected to the second scan line, the high-level signal line, the low-level signal line, and the second clock signal.

5. The drive circuit of a display panel according to claim 2, wherein the non-display region further comprises:
a data control line;
the data control line comprises a first data control line and a second data control line;
the data line comprises a first data line and a second data line;
the first data line is connected to the first data control line, and the second data line is connected to the second data control line; and
the first data line and the second data line are intersected at intervals.

6. The drive circuit of a display panel according to claim 2, wherein the first scan lines are arranged adjacent to each other; and the second scan lines are arranged adjacent to each other.

7. The drive circuit of a display panel according to claim 1, wherein all the active switches are connected to the same alignment control line.

8. A drive circuit of a display panel, the display panel comprising a display region, a non-display region, and a drive circuit, the non-display region surrounding the display region;
the display region comprises:
a plurality of scan lines; and
a plurality of data lines intersected with the scan lines;
the non-display region comprises:
a gate drive chip connected to the scan lines; and
a data control line connected to the data lines;
the drive circuit comprises:
an alignment control line intersected with the scan lines; and
an active switch with a gate electrode and a source electrode being connected to the alignment control line, and a drain electrode being connected to the scan lines;
the alignment control line comprises a first alignment control line and a second alignment control line; the active switch comprises a first active switch and a second active switch; and the scan line comprises a first scan line and a second scan line;
the first active switch is separately connected to the first alignment control line and the first scan line; and the second active switch is separately connected to the second alignment control line and the second scan line;
the first scan line and the second scan line are intersected at intervals;
the drive circuit further comprises:
a gate control line, configured to control the gate drive chip and comprising a high-level signal line, a low-level signal line, a first clock signal and a second clock signal;
the gate drive chip comprises a first gate drive chip and a second gate drive chip;
the first gate drive chip is separately connected to the first scan line, the high-level signal line, the low-level signal line, and the first clock signal; and the second gate drive chip is separately connected to the second scan line, the high-level signal line, the low-level signal line, and the second clock signal;
the data control line comprises a first data control line and a second data control line;
the data line comprises a first data line and a second data line;
the first data line is connected to the first data control line, and the second data line is connected to the second data control line; and
the first data line and the second data line are intersected at intervals.

9. A driving method for a drive circuit of a display panel, the display panel comprising a display region, a non-display region and a drive circuit, the non-display region surrounding the display region;
the display region comprises:
a plurality of scan lines; and
a plurality of data lines intersected with the scan lines;
the non-display region comprises:
a gate drive chip connected to the scan lines;
the drive circuit comprises:
an alignment control line intersected with the scan lines; and
an active switch with a gate electrode and a source electrode being connected to the alignment control line, and a drain electrode being connected to the scan lines;
the driving method comprises:
controlling the alignment control line to output a high-level signal; and
transmitting the high-level signal to the scan line through an active switch.

10. The driving method for a drive circuit of a display panel according to claim 9, wherein the driving method further comprises:
closing the gate drive chip when it is detected that the potentials of all scan lines are at high level.

11. The driving method for a drive circuit of a display panel according to claim 9, wherein the alignment control line comprises a first alignment control line and a second alignment control line; the active switch comprises a first active switch and a second active switch; and the scan line comprises a first scan line and a second scan line;
the first active switch is separately connected to the first alignment control line and the first scan line; and the second active switch is separately connected to the second alignment control line and the second scan line.

12. The driving method for a drive circuit of a display panel according to claim 10, wherein the first scan line and the second scan line are intersected at intervals.

13. The driving method for a drive circuit of a display panel according to claim 10, wherein the drive circuit further comprises:
a gate control line, configured to control the gate drive chip and comprising a high-level signal line, a low-level signal line, a first clock signal and a second clock signal;
the gate drive chip comprises a first gate drive chip and a second gate drive chip; the first gate drive chip is separately connected to the first scan line, the high-level signal line, the low-level signal line, and the first clock signal; and the second gate drive chip is separately connected to the second scan line, the high-level signal line, the low-level signal line, and the second clock signal.

14. The driving method for a drive circuit of a display panel according to claim 10, wherein the non-display region further comprises:
a data control line;
the data control line comprises a first data control line and a second data control line;
the data line comprises a first data line and a second data line;
the first data line is connected to the first data control line, and the second data line is connected to the second data control line; and
the first data line and the second data line are intersected at intervals.

15. The driving method for a drive circuit of a display panel according to claim 10, wherein the first scan lines are arranged adjacent to each other; and the second scan lines are arranged adjacent to each other.

16. The driving method for a drive circuit of a display panel according to claim 9, wherein all the active switches are connected to the same alignment control line.

17. The driving method for a drive circuit of a display panel according to claim 9, wherein all the active switches comprise thin-film transistors.
